(19) United States
(12) Patent Application Publication
(10) Pub. No.: US 2008/0108360 A1
(43) Pub. Date: May 8, 2008

(54) SYSTEM AND METHOD FOR REASSIGNING AN ACTIVE CALL TO A NEW COMMUNICATION CHANNEL

(75) Inventors: MATTHEW A. BAARMAN, BARTLETT, IL (US); JEFFREY F. THURSTON, LAKE ZURICH, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/555,852

(22) Filed: Nov. 2, 2006

(51) Int. Cl. H04Q 7/20

(52) U.S. Cl. 455/450

(57) ABSTRACT

A zone controller is configured to send a first channel grant signal to a base site to assign a call to a first communication channel and then subsequently send a second channel grant signal to the base site upon determining that the call should be reassigned to a second communication channel. The base site, which is coupled to the zone controller, is configured to receive the second channel grant signal, and begin broadcasting the call on the second channel upon receiving the second channel grant signal. Once the call is being broadcast on the second channel, the base site transmits a transition grant signal to the communication units. Upon receiving the transition grant signal, the communication units switch from the first communication channel to the second communication channel. The call is deassigned from the first communication channel to make the first communication channel available for other calls or services.

### TECHNICAL FIELD OF THE DISCLOSURE

This disclosure relates generally to communication systems, and more particularly, to a system and method for reassigning an active call to a new communication channel.

### BACKGROUND OF THE DISCLOSURE

Communication systems typically include a plurality of dispatch consoles and communication units, such as mobile or portable radio units, that are geographically distributed among various base sites and console sites. The communication units wirelessly communicate with the base sites and each other, and are often logically divided into various talkgroups. The base sites are also coupled to a controller that controls communications within the system.

Whenever a call is initiated in the communication system, the controller assigns the call to an available wireless transmission channel by transmitting channel grant signals to the relevant base sites. The channel assignments are then advertised by the base sites to the communication units to inform the communication units of the particular channel on which the call will be broadcast. Typically, the selected channel for each call is determined by a preset static algorithm that assigns each call to the least capable available channel that meets all of the requirements for transmitting that call.

However, there are numerous disadvantages with this procedure. First, as the controller does not actually know what types of calls it will receive in the future, it is unable to intelligently reserve channels with the proper capabilities to reliably handle the future calls. Furthermore, once a call is assigned to a particular communication channel in present systems, that channel assignment cannot be altered for the duration of the call (in other words, in present systems, the call cannot be re-assigned to a different communication channel at a base site). As a result, the system is not capable of updating existing channel assignments based on altered conditions or new call requests at a base site.

Accordingly, there is a need for a system and method for efficiently reassigning an active call to a different communication channel in a communication system.

### BRIEF DESCRIPTION OF THE FIGURES

Various embodiment of the disclosure are now described, by way of example only, with reference to the accompanying figures.

FIG. 1 shows one embodiment of a communication system according to the present disclosure.

FIG. 2 is a flow chart illustrating one embodiment of a method for assigning a call to a communication channel in the system of FIG. 1.

FIG. 3 is a flow chart illustrating one embodiment of a method for re-assigning the call to a new communication channel according to the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

A system and method for efficiently reassigning an active call transmitted on a first communication channel to a second communication channel at a single base site is disclosed. It should be noted that the call can be reassigned to a new channel any number of times for the duration of the call. It should also be noted that a communication channel can be any channel that conveys communication, such as a traffic channel, a control channel or the like. Thus, the present disclosure can assign and reassign a call to any type of communication channel. When a call is first initiated, the call is assigned to a first communication channel. This is accomplished by sending a first channel grant signal to a base site. Upon receiving the first channel grant signal, the base site begins broadcasting the call on the first communication channel. The base site also advertises the first channel assignment to communication units in range of the base site. Authorized communication units then begin transmitting and/or receiving the call on the first communication channel.

If, during the call, there is a need to move the call to another communication channel, a second channel grant signal is sent to the base site re-assigning the call to a second communication channel, and the base site begins to broadcast the call on the second communication channel. Once the base site is broadcasting on the second communication channel, a transition grant signal is sent to the base site. The transition grant signal is broadcast by the base site to instruct any communication units receiving the call on the first communication channel to switch to the second communication channel to receive the call. The first communication channel is then deassigned and made available for use by another call or service.

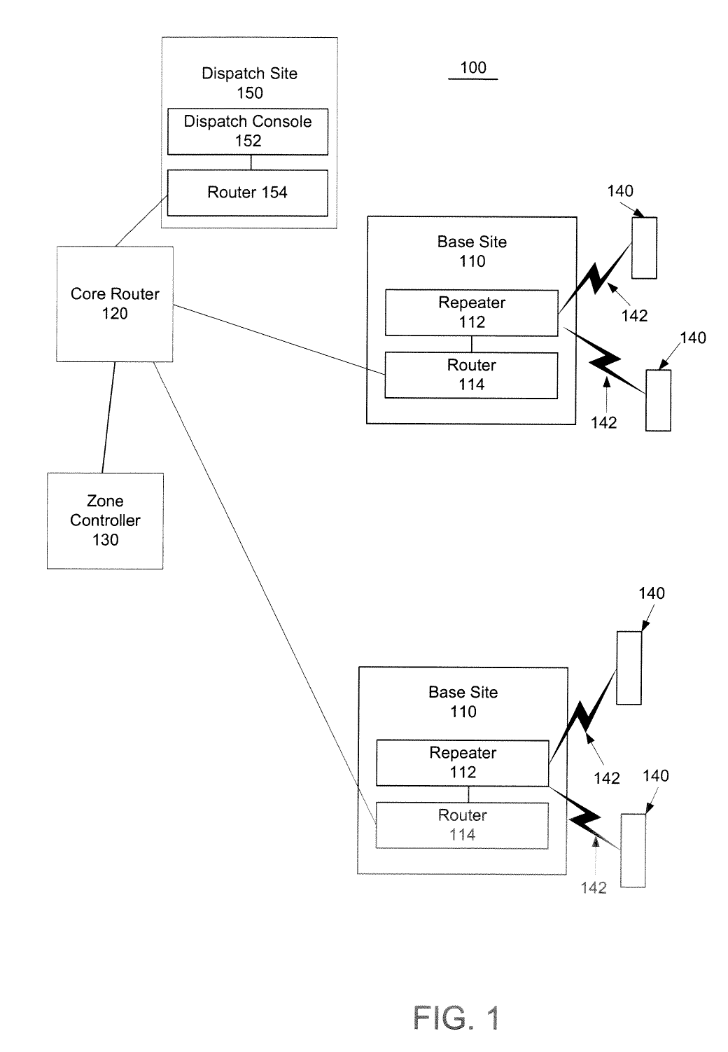

Let us now refer to the figures to describe the present disclosure in greater detail. FIG. 1 shows one embodiment of a communication system in accordance with the present disclosure. The system 100 comprises a plurality of base sites 110 that are in communication with a core router 120. The core router 120 is also coupled to a zone controller 130. The zone controller 130 manages and assigns internet protocol (IP) multicast addresses for payload (e.g., voice, data, video, etc.) and control messages between and among the various base sites 110.

Each base site 110 is comprised of at least one repeater 112 that communicates using wireless communication resources 142 with communication units 140. The communication units 140 may be mobile or portable wireless radio units, cellular radio/telephones, video terminals, portable computers with wireless modems, or any other wireless devices. The repeater 112 is coupled, for example via Ethernet, to an associated router 114, which is in turn coupled to the core router 120.

The core router 120 may also be further coupled to a dispatch site 150. As shown in FIG. 1, the dispatch site 150 includes at least one dispatch console 152 that is coupled, for example, via Ethernet to a router 154, which is in turn coupled to the core router 120. Although not shown in FIG. 1, it will be appreciated that a single site may include both repeaters and dispatch consoles. It should be noted that even though Ethernet links are referenced above, the base sites 110, the core router 120, the zone controller 130 and the dispatch site 150 may be coupled using T1 lines, E1 lines, fiber optic lines, wireless links, or any other suitable means for transporting data between the various components.

Practitioners skilled in the art will appreciate that the system 100 may also include various other elements not shown in FIG. 1. For example, the system 100 may include base sites configured to provide simulcast transmissions. The system 100 may also be linked to a public switched telephone network (PSTN), a paging network, a facsimile machine, or the like. The communication system 100 may also be connected to a number of additional content sources, such as the Internet or various Intranets.

The wireless communication resources 142 used by the base sites 110 to communicate with the communication units 140 may comprise any communication resource such as, for example, radio frequency (RF) technologies, including, but not limited to Code Division Multiple Access (CDMA), Time Division Multiple Access (TDMA), Frequency Division Multiple Access (FDMA), and the like. The present disclosure may also be used in any of the currently available RF communication systems, such as, for example, Global System for Mobile communication (GSM), General Packet Radio Service (GPRS), Universal Mobile Telecommunications Service (UMTS), Trans-European Trunked Radio service (TETRA), Association of Public Safety Communication Officers (APCO) Project 25, Personal Communication Service (PCS), Advanced Mobile Phone Service (AMPS), Integrated Dispatch Enhanced Network (iDEN), and the like. Other wireless technologies, such as those now known or later to be developed and including, but not limited to, infrared, Bluetooth, electric field, electromagnetic, or electrostatic transmissions, may offer suitable substitutes.

In one exemplary embodiment in accordance with the present disclosure, the wireless communication resources 142 comprise multiple communication channels used for transmissions from the base sites 110 to communication units 140 (outbound link) and transmissions from the communication units 140 to the base sites 110 (inbound link). As would be understood by one skilled in the art, the nature of the communication channels will differ depending on the type of system being used. For example, in a FDMA system, each channel comprises a pair of frequency carriers. One frequency carrier of the pair is used for the outbound link while the other frequency carrier of the pair is used for the inbound link. In TDMA systems, however, each frequency carrier is divided into a plurality of time slots, each of which may be allocated to a separate call. Portions of a call (also referred to as bursts) are then transmitted during an allocated time slot.

It should also be understood that multiple modulation schemes may also be used in a single communication system. For example, a dual FDMA/TDMA communication system may be capable of transmitting both FDMA calls and TDMA calls. In such a system, a single frequency carrier may be used for transmitting either one FDMA call or a plurality of TDMA calls based on the available number of TDMA time slots.

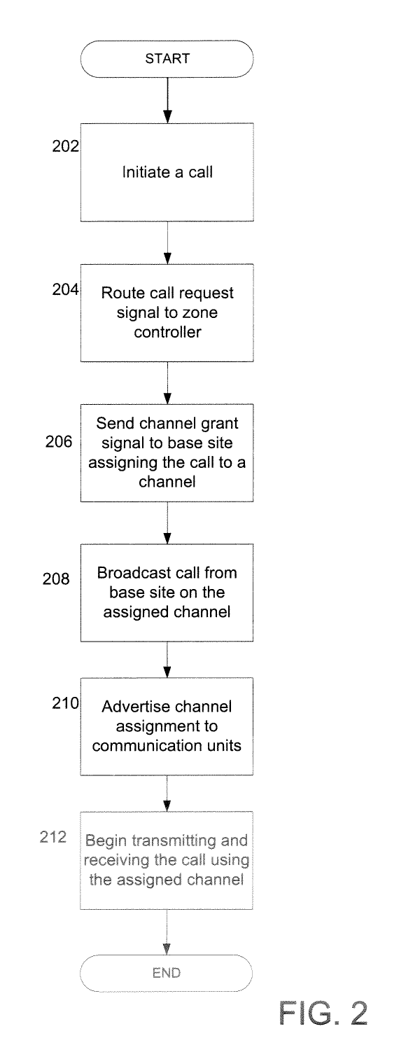

Let us now refer to one embodiment of a method for assigning a new call to a communication channel in the communication system 100 as illustrated in FIG. 2. In step 202, a transmitting unit (such as a communication unit 140, a dispatch site 150, base site 110, or any other type of component capable of transmitting a call) initiates a call and transmits a call request signal. The call request signal is routed to the zone controller 130 (step 204) which, upon receiving the call request signal, sends a channel grant signal to at least one base site 110 assigning a call to a communication channel (step 206). It should be understood that if channel grant signals are sent to multiple base sites (i.e., a multi-site call), each base site 110 may be instructed to assign the call to a different communication channel. Each base site 110 receiving the channel grant signal begins broadcasting the call on the assigned communication channel in step 208. In step 210, if the assigned communication channel is a traffic channel, each base site 110 also advertises the channel assignment on a control channel to inform any authorized communication units (for example, communication units in the same talk group) of the assigned communication channel for the call. As would be understood by one skilled in the art, a control channel may be a dedicated communication channel used by one or more base sites 110 for transmitting various call initiation signals and identification codes but is not necessarily limited to use by only the base site or limited to transmitting only specific type of information. Any communication units 140 that receives the control channel and is authorized to receive the call begins transmitting and/or receiving the call on the assigned communication channel in step 212.

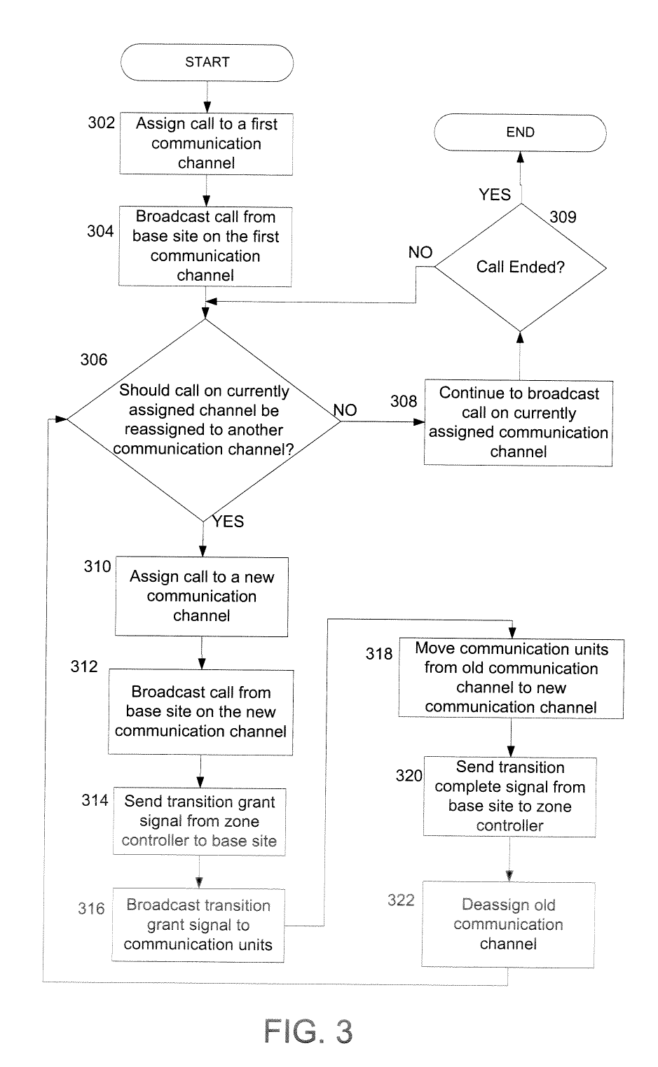

According to one exemplary embodiment of the present disclosure, FIG. 3 illustrates a method for re-assigning a call that was originally assigned to a first communication channel at a particular base site 110 (for example, by using the method in FIG. 2) to a second communication channel. From brevity purposes only, it should be noted that the following text for FIG. 3 assumes that the call is reassigned from a first communication channel to a second communication channel even though FIG. 3 depicts that multiple reassignments to different communication channels during the duration of the call is possible and still remain within the spirit and scope of the disclosure. For purposes of this disclosure, the call may originate from any component in the system, including a communication unit 140, a base site 110, a dispatch site 150, or any other component capable of transmitting a call. The term “call”, as used herein, also includes any type of multimedia transmission (such as voice, data, or video), as well as transmissions comprising system control information (such as a control channel).

In this exemplary embodiment, a call is first assigned to a first communication channel in step 302, and the call is broadcast from the base site on the first communication channel in step 304. In step 306, it is determined whether the call needs to be reassigned to another communication channel. It should be noted that if multiple sites are included in the call, the zone controller makes the determination of whether the call needs to be moved to another communication channel for each site. For purposes of brevity, the flow chart of FIG. 3 illustrates the algorithm for one site. There are numerous situations where it may be desirable to reassign a call to another communication channel. For example, in a mixed FDMA/TDMA system, one time slot on a frequency carrier may be assigned to a TDMA call while the other time slot(s) on the frequency carrier remains unused. In this instance, if a new FDMA call is initiated, it may be desirable to reassign the TDMA call to an available time slot on another frequency carrier at a base site in order to make the originally assigned frequency carrier available for the FDMA call (which requires an entire frequency carrier for transmission).

In another example, a communication system may be configured to communicate with both sub-band restricted (SBR) communication units and unrestricted communication units. A SBR communication unit is restricted to using only a subset of the available communication channels at a base site (also referred to as SBR channels), while unrestricted communication units are capable of using all the communication channels at a base site. In such a system, it may be desirable to reassign an active call to a new communication channel at a base site for an unrestricted communication unit to a non-SBR communication channel if the unrestricted communication unit is using one of the SBR communication channels when a SBR communication unit initiates a call.

In a third example, it may also be desirable to reassign an active call to a new communication channel at a base site to make available resources that were limited as a result of dynamic frequency blocking (DFB). As would be understood by one skilled in the art, DFB is a feature used by communication systems to eliminate interference between two communication channels at different base sites. Thus, if communication channel A at a first base site is interfering with communication channel B at a second base site, the zone controller blocks or prevents a call from occurring on communication channel B if there is a call on communication channel A. Typically, in order to preserve resources, a call is only assigned to a communication channel that causes such interference once all other available non-interfering channels at the base site are used. It may therefore be desirable to reassign the active call currently assigned to an interfering communication channel to a non-interfering communication channel once a non-interfering communication channel becomes available.

In a fourth example, it may be desirable to reassign an active call to another communication channel at a base site in order to allow for timely base site identification (BSI). Specifically, the Federal Communications Commission requires that certain communication systems perform base site identification at predetermined intervals, such as thirty minutes. To accomplish this, certain frequency carriers in the system are configured to be BSI capable. Every thirty minutes, the zone controller attempts to assign the BSI capable carriers to emit a BSI signal. However, if a call is active on the BSI capable frequency carrier, the BSI signal emission must be delayed until the end of the call. Accordingly, it may be desirable to reassign the active call from a BSI capable communication channel to a non-BSI capable communication channel when a BSI emission is scheduled.

In yet a fifth example, it may also be desirable to reassign an active call to a different communication channel at a base site if problems or delays are detected on the originally assigned channel at the base site. For example, when interference is present on the originally assigned communication channel, when the original communication channel malfunctions, or the like.

Of course, the above examples are not meant to be exhaustive of all scenarios in which it may be advantageous to reassign an active call from one communication channel to another communication channel at a base site, and one skilled in the art would readily understand other instances in which the present disclosure may be applied.

Referring back to the flow chart of FIG. 3, if the zone controller (or other suitable device) determines in step 306 that the call does not need to be reassigned to another communication channel at the base site, the call continues to be transmitted on the originally assigned first communication channel in step 308. Throughout the duration of the call, however, the zone controller determines whether it is advantageous to reassign the call to another communication channel at the base site. Thus, if the call has not ended at step 309, the algorithm loops back to step 306 and the zone controller reassess whether the call should be reassigned to another communication channel at the base site. If, however, the zone controller determines in step 306 that the call is to be reassigned to another communication channel at the base site, the algorithm proceeds to step 310.

In step 310, the zone controller 130 reassigns the call to a second communication channel at a base site. In one embodiment, this is accomplished by transmitting a second channel grant signal from the zone controller 130 to the base site 110. At this time, the base site 110 may also begin advertising the second channel assignment on a control channel to inform any new communication units 140 entering within range of the base site 110 that the call is now being transmitted on the second communication channel. The zone controller 130 may also cancel the first channel grant signal previously assigning the call to the first communication channel so that the first channel assignment is no longer being advertised.

In step 312, the base site 110 begins broadcasting the call on the second communication channel by duplicating any information from the first communication channel to the second communication channel. The base site 110 also continues to broadcast the call on the first communication channel. In one embodiment, a synchronization signal may also be used to synchronize the transmissions on the first and second communication channels.

The zone controller 130 sends a transition grant signal to the base site 110 in step 314. In one embodiment, the zone controller 130 may be configured to send the transition grant signal upon the expiration of a predetermined amount of time after sending the second channel grant signal. The predetermined amount of time is preferably chosen to allow sufficient time for the base site 110 to process the second channel grant signal and begin broadcasting the call on the second communication channel. In another embodiment, the base site 110 may be configured to transmit a ready signal to the zone controller 130 once the base site 110 has begun broadcasting the call on the second communication channel. The zone controller 130 may then send the transition grant signal upon receiving the ready signal from the base site 110.

Upon receiving the transition grant signal from the zone controller, the base site 110 broadcasts the transition grant signal to the communication units 140 in step 316. The transition grant signal may be broadcast on any type of communication channel, such as a traffic channel or a control channel. For example, in one embodiment, the transition grant signal may be broadcast on the first communication channel originally assigned to the call. More particularly, when using TDMA modulation, the transition grant signal may be broadcast as a link control or other embedded signal within a TDMA burst on the first communication channel. In another embodiment, the transition grant signal may also be broadcast to the communication units 140 as control information on the control channel. The base site 110 may also be configured to transmit the transition grant signal a multiple number of times to ensure that the transition grant signal is received by the communication units 140 listening to the call.

Upon receiving the transition grant signal from the base site, the communication units 140 switch from the first communication channel to the second communication channel in step 318. To minimize the loss of call information, the communication units 140 may be configured to intelligently determine the best moment in time to make the switch from the first communication channel to the second communication channel. For example, in an embodiment using TDMA modulation, the communication unit 140 may switch from the first communication channel to the second communication channel during a time when the communication unit 140 is not receiving on its assigned time slot. In another embodiment, the communication unit 140 may also be configured to prioritize the received information and switch from the first communication channel to the second communication channel when receiving call information that is less critical.

The base site 110 sends a transition complete signal to the zone controller 130 in step 320. In one embodiment, the transition complete signal is sent from the base site once a predetermined number of transition grant signals have been broadcast to the communication units. In step 322, the zone controller 130 deassigns the first communication channel so that it is available to be used by another call or service. In this particular example, the zone controller determines that the call does not need to be reassigned to yet another communication channel (at step 306), so the call continues to be broadcasted on the second communication channel until it ends at step 309.

By means of the aforementioned disclosure, a communication system is provided that is capable of reassigning an active call to a different communication channel at a base site. It should also be understood that while the flowchart in FIG. 3 illustrates a method for reassigning a call in a single instance, the present disclosure may also be employed periodically or continuously to dynamically alter the call channel assignments for the call. As a result, the communication system has the flexibility to adapt and alter the call channel assignments for the call based on varying conditions and newly received calls in order to more efficiently use the available resources of the system.

Further advantages and modifications of the above described system and method will readily occur to those skilled in the art. For example, although a communication channel has been described above as comprising a pair of frequency carriers, a pair of time slots, or the like, a system may also be designed wherein the frequency carriers, time-slots, etc. are not paired for each communication channel. In such a system, the present disclosure may be used to reassign a call to a communication channel for an outbound link independent of a communication channel for an inbound link, or vice versa. Accordingly, the present disclosure may also be used to reassign calls for only certain communication units (for example, receiving communication units as opposed to transmitting communication units) rather than all communication units associated with the call.

The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for reassigning a call being transmitted on a first communication channel to a second communication channel, the method comprising, at a base site:
receiving a first channel grant signal assigning the call to the first communication channel;
broadcasting the call on the first communication channel;
receiving a second channel grant signal reassigning the call to the second communication channel;
broadcasting the call on the second communication channel;
transmitting a transition grant signal to at least one communication unit to direct the at least one communication unit to switch from the first communication channel to the second communication channel; and
ceasing broadcast of the call on the first communication channel.

2. The method of claim 1 wherein broadcasting the call from the base site on the second communication channel includes duplicating information from the first communication channel to the second communication channel.

3. The method of claim 1 wherein transmitting the transition grant signal includes broadcasting the transition grant signal on the first communication channel.

4. The method of claim 1 wherein transmitting the transition grant signal includes broadcasting the transition grant signal multiple times on the first communication channel.

5. The method of claim 1 wherein if the first communication channel is a traffic channel, transmitting the transition grant signal includes broadcasting the transition grant signal on a control channel.

6. The method of claim 1 wherein the first communication channel comprises a plurality of time division multiple access (TDMA) time slots.

7. The method of claim 6 wherein the transition grant signal is broadcast as a link control signal within a TDMA burst transmitted on one of the plurality of TDMA time slots.

8. The method of claim 1 further comprising sending a ready signal to a zone controller once the base site has begun broadcasting the call on the second communication channel; whereby the transition grant signal is sent from the zone controller to the base site upon the zone controller receiving the ready signal.

9. The method of claim 1 further comprising sending a transition complete signal to the zone controller after transmitting at least one transition grant signal.

10. A method for reassigning a call being transmitted on a first channel to a second communication channel, the method comprising, at a zone controller:
sending a first channel grant signal to a base site assigning the call to the first communication channel;
determining that the call should be moved to the second communication channel;
sending a second channel grant signal to the base site assigning the call to the second communication channel;
sending a transition grant signal to the base site granting permission for the base site to direct at least one communication unit to switch from the first communication channel to the second communication channel; and
deassigning the call from the first communication channel.

11. The method of claim 10 further including receiving a ready signal from the base site indicating that the base site has started broadcasting the call on the second communication channel, and wherein the transition grant signal is sent to the base site upon receiving the ready signal.

12. The method of claim 10 wherein the transition grant signal is sent a predetermined amount of time after sending the second channel grant signal.

13. The method of claim 10 further including receiving a transition complete signal from the base site; and deassigning the call from the first communication channel upon receipt of the transition complete signal at the zone controller.

14. A method for reassigning a call being transmitted on a first communication channel to a second communication channel, the method comprising, at a communication unit:
wirelessly communicating with a base site on the first communication channel to transmit or receive the call;
receiving a transition grant signal from the base site during the call;
switching from the first communication channel to the second communication channel upon receiving the transition grant signal; and
wirelessly communicating with the base site on the second communication channel to transmit or receive the call.

15. The method of claim 14 wherein receiving a transition grant signal includes receiving a transition grant signal from the base site on the first communication channel.

16. The method of claim 14 wherein, if the first communication channel is a traffic channel, receiving a transition grant signal includes receiving a transition grant signal from the base site on a control channel.

17. A system capable of reassigning a call being transmitted on a first channel to a second communication channel comprising:
a zone controller configured to send a first channel grant signal that assigns the call to the first communication channel, and to subsequently send a second channel grant signal that assigns the call to the second communication channel upon determining that the call should be reassigned to the second communication channel;
a base site coupled to the zone controller, the base site being configured to receive the first channel grant signal, to begin broadcasting the call on the first communication channel upon receipt of the first channel grant signal, to subsequently receive the second channel grant signal, to begin broadcasting the call on the second communication channel upon receiving the second channel grant signal, and to transmit a transition grant signal after broadcasting the call on the second communication channel; and
at least one communication unit in wireless communication with the base site, the at least one communication unit being configured to transmit or receive the call on the first communication channel, to receive the transition grant signal from the base site, and to switch from the first communication channel to the second communication channel upon receiving the transition grant signal.

18. The system of claim 17 wherein the base site receives the transition grant signal from the zone controller.

19. The system of claim 17 wherein the first and second communication channels each comprises a plurality of time division multiple access time slots, and wherein the at least one communication unit is configured to switch from the first communication channel to the second communication channel during a time slot when the at least one communication unit is not receiving the call.

20. The system of claim 17 wherein the zone controller is further configured to deassign the call from the first communication channel.
